(19) United States
(12) Patent Application Publication
(10) Pub. No.: US 2015/0166406 A1
(43) Pub. Date: Jun. 18, 2015

(54) CHEMICALLY STRENGTHENED GLASS PLATE

(71) Applicant: Asahi Glass Company, Limited, Tokyo (JP)

(72) Inventors: Masayuki ISHIMARU, Tokyo (JP); Yusuke KOBAYASHI, Tokyo (JP)

(73) Assignee: Asahi Glass Company, Limited, Tokyo (JP)

(21) Appl. No.: 14/634,092

(22) Filed: Feb. 27, 2015

Related U.S. Application Data
(63) Continuation of application No. PCT/JP2014/080534, filed on Nov. 18, 2014.

(30) Foreign Application Priority Data
Nov. 22, 2013 (JP) 2013-242354

(51) Int. Cl. C03C 21/00

(52) U.S. Cl. CPC C03C 21/002

(57) ABSTRACT

A chemically strengthened glass plate includes a top and bottom main surfaces and end surfaces between the top and bottom main surfaces, and includes a compressive stress layer in a whole surface of the main surfaces and end surfaces, and has a thickness of 0.75 mm or less, a surface compressive stress of 850 MPa or more, a thickness of the compressive stress layer of 20 to 35 μm and an internal tensile stress of 42 MPa or less. The end surface has a chamfered portion, and a depth of a latent scratch is 20 μm or less in a portion of the end surface corresponding to a distance that is within ⅕ of the thickness of the chemically strengthened glass plate in a thickness direction from the main surface adjacent to the chamfered portion.

### CROSS-REFERENCE TO RELATED APPLICATIONS

This application is a continuation of prior International Application No. PCT/JP2014/080534 filed on Nov. 18, 2014, which is based upon and claims the benefit of priority from Japanese Patent Application No. 2013-242354 filed on Nov. 22, 2013; the entire contents of all of which are incorporated herein by reference.

### BACKGROUND OF THE INVENTION

1. Field of the invention

The present invention relates to chemically strengthened glass plates.

2. Discussion of the Background

It has become increasing popular to use a cover glass (protective glass) for mobile devices such as mobile phones, PDAs and tablet PCs, touch panels, and display devices such as liquid crystal televisions for the purposes of protecting the display, and improving the appearance of the display. The cover glass of flat-panel televisions such as liquid crystal televisions are sometimes subjected to surface treatments, for example, such as formation of films having functions such as antireflection, impact failure prevention, electromagnetic wave shielding, near infrared shielding, and color tone correction. For such a display device, weight reduction and thickness reduction are required for differentiation by a flat design or for reduction of the load for transportation. Thus, a cover glass to be used for protecting a display is also required to be thin. However, if the thickness of the cover glass is made to be thin, the strength is lowered and the cover glass cannot accomplish the essential role to protect a display device.

In order to solve the above problem, it is conceivable to improve the strength of the cover glass, and as such a method, a method to form a compressive stress layer on a glass surface is commonly known. The method to form a compressive stress layer on a glass surface, may typically be an air quenching tempering method (physical tempering method) in which a surface of a glass plate heated to near the softening point is quenched by air cooling or the like, or a chemical strengthening method in which alkali metal ions having a small ion radius (typically Li ions or Na ions) at a glass plate surface are exchanged with alkali ions having a large ion radius (typically K ions) by ion exchange at a temperature lower than the glass transition point.

As described above, the thickness of the cover glass is required to be thin. However, if the air quenching tempering method is applied to a thin glass plate having a thickness of less than 2 mm, as required for a cover glass, the temperature difference between the surface and the inside tends not to arise, and it is thereby difficult to form a compressive stress layer, and the desired property of high strength cannot be obtained. Therefore, a cover glass tempered by the latter chemical strengthening method is usually used.

A more recent technique that is expected to have use in liquid crystal displays is the direct bonding technique that bonds the cover glass to a display device or the like with a resin material or the like for achieving high display contrast with reduced reflection, and producing clear display images (for example, JP-A-2009-186959 (KOKAl)).

### SUMMARY OF INVENTION

According to one aspect of the present invention, the following chemically strengthened glass plate is provided.

<1> A chemically strengthened glass plate comprising a top main surface, a bottom main surface and end surfaces between the top main surface and the bottom main surface, and comprising a compressive stress layer in a whole surface of the main surfaces and end surfaces,

wherein the chemically strengthened glass plate has a thickness of 0.75 mm or less, a surface compressive stress of 850 MPa or more, a thickness of the compressive stress layer of 20 to 35 μm and an internal tensile stress of 42 MPa or less, and the end surface has a chamfered portion, and a depth of a latent scratch is 20 μm or less in a portion of the end surface corresponding to a distance that is within ⅕ of the thickness of the chemically strengthened glass plate in a thickness direction from the main surface adjacent to the chamfered portion.

<2> The chemically strengthened glass plate according to <1>, wherein the thickness of the surface compressive stress layer is 20 to 30 μm.

<3> The chemically strengthened glass plate according to <2>, wherein the thickness of the surface compressive stress layer is 20 to 25 μm.

<4> The chemically strengthened glass plate according to <3>, wherein the internal tensile stress is 30 MPa or less.

<5> The chemically strengthened glass plate according to <1>, wherein the surface compressive stress is 966 MPa or less.

<6> The chemically strengthened glass plate according to <1>, wherein the internal tensile stress is 35 MPa or less.

<7> The chemically strengthened glass plate according to <6>, wherein the surface compressive stress is 980 MPa or less.

<8> The chemically strengthened glass plate according to <6>, wherein the internal tensile stress is 30 MPa or less.

<9> The chemically strengthened glass plate according to <1>, wherein a bending strength by a 4-point bending test is 500 MPa or more.

<10> The chemically strengthened glass plate according to <7>, wherein the chamfered portion is polished with a grinding stone with a grain number of #600 or more.

<11> The chemically strengthened glass plate according to <1>, a load F₅₀ (unit: kgf) at which there is a 50% probability of breakage occurring under an applied load of a pyramidal diamond indenter having a vertex angle of 110° on a Vickers hardness tester is 2.5 kgf or more.

<12> The chemically strengthened glass plate according to <1>, which has a Young's modulus of 65 GPa or more.

<13> The chemically strengthened glass plate according to <1>, which has a Poisson's ratio of 0.25 or less.

<14> The chemically strengthened glass plate according to <1>, comprising, as represented by mole percentage based on the following oxides: from 56 to 75% of SiO₂; from 5 to 20% or Al₂O₃; from 8 to 22% of Na₂O; from 0 to 10% of K₂O; from 0 to 14% of MgO; from 0 to 5% of ZrO₂; and from 0 to 5% of CaO.

<15> The chemically strengthened glass plate according to <14>, wherein a total content of SiO₂, Al₂O₃, Na₂O and MgO is 98% or more.

<16> The chemically strengthened glass plate according to <14>, wherein SiO2—MgO is 64% or less.

<17> The chemically strengthened glass plate according to <14>, wherein Al₂O3—MgO is 9% or less.

<18> The chemically strengthened glass plate according to <14>, wherein ZrO₂ is contained in an amount of 0 to 2%.

<19> The chemically strengthened glass plate according to <14>, wherein B₂O₃ is contained in an amount of 0 to 6%.

<20> The chemically strengthened glass plate according to <14>, wherein Li₂O is contained in an amount of 0 to 1%.

### BRIEF DESCRIPTION OF THE DRAWINGS

FIG. 1 is a cross sectional view showing a chemically strengthened glass plate including an end surface in an embodiment of the present invention.

FIG. 2 is a cross sectional view showing a chemically strengthened glass plate containing with an etched end surface in an embodiment of the present invention.

FIG. 3 is a partially enlarged cross sectional view of FIG. 2.

FIG. 4 is a graph representing the relationship between surface compressive stress CS and bending strength by a 4-point bending test.

FIG. 5 is a graph representing the relationship between the thickness of a surface compressive stress layer (DOL) and bending strength.

FIG. 6 is a graph representing the relationship between surface compressive stress CS and fracture energy by a falling ball test.

FIG. 7 is a graph representing the relationship between surface compressive stress CT and F₅₀ by a pyramidal indenter indentation test.

FIG. 8 is a schematic diagram representing a falling ball test for reproducing breakage (3) that occurs from a main surface, on the side of the top surface, of a chemically strengthened glass plate.

FIG. 9 is a graph representing changes in strength with respect to changes of internal tensile stress CT for an experiment using a hard base.

FIG. 10 is a graph representing changes in strength with respect to changes of internal tensile stress CT for an experiment using a soft base.

FIG. 11 is a Weibull plot representing the 4-point bending strength of a chemically strengthened glass plate in an embodiment of the present invention.

FIG. 12 is a graph representing the relationship between the latent scratch depth and the strength of a chemical strengthened glass plate.

FIG. 13 is a schematic diagram representing a method for producing the chemically strengthened glass plate according to an embodiment of the present invention.

### DESCRIPTION OF THE EMBODIMENTS

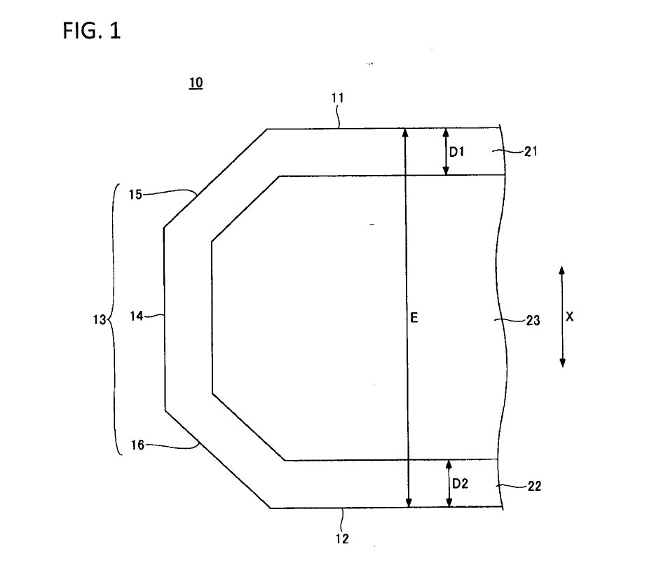

Embodiments of the present invention are described below. Note that the present invention is not limited to the following embodiments. FIG. 1 is a cross sectional view showing a chemically strengthened glass plate 10 containing an end surface in an embodiment of the present invention. The chemically strengthened glass plate 10 includes a top main surface 11 and a bottom main surface and 12, and an end surface 13 adjacent to the main surfaces 11 and 12. The two main surfaces 11 and 12 are flat surfaces that are parallel to each other.

The end surface 13 includes a flat portion 14 perpendicular to the two main surfaces 11 and 12, and chamfered potions 15 and 16 formed between the flat portion 14 and the main surfaces 11 and 12. The flat portion 14 may be a cut surface that results from cutting the chemically strengthened glass plate 10 from a larger plate glass, or a processed surface that results from processing the cut surface.

The number of chamfered portions 15 and 16 is not particularly limited. For example, four chamfered portions may be provided that correspond to the four sides of the rectangular main surfaces 11, 12, or only one chamfered portion may be provided. It is, however, preferable to provide chamfered portions for all sides to more desirably reduce the breakages (1) and (2) described below.

The chamfered portions 15 and 16 result from removing the corners where the cut surface or processed surface meets the main surfaces. The chamfered portions 15 and 16 are, for example, flat surfaces oblique to the main surfaces 11 and 12. The chamfered portions 15 and 16, shown as having the same dimensional shape in FIG. 1, may have different dimensional shapes.

In the present embodiment, the chamfered portions 15 and 16 are flat surfaces oblique to the main surfaces 11 and 12. However, the chamfered portions 15 and 16 may be curved surfaces, as long as these surfaces gradually extend outwardly from the main surfaces 11 and 12 towards the flat surface 14 relative to the thickness direction (X direction). In this case, the chamfered portions 15 and 16 may be joined to each other instead of providing the flat portion 14, and may have substantially the same curvature radius.

The chemically strengthened glass plate 10 has, in the main surfaces 11 and 12, chemically strengthened layers (compressive stress layers) 21 and 22 of predetermined thicknesses from the main surfaces 11 and 12, respectively. The compressive stress layers are formed by immersing the glass in an ion-exchange treatment solution. The compressive stress layers of predetermined thicknesses from the glass surfaces is formed by replacing ions having smaller radius (for example, Li ions, Na ions) contained in the glass surfaces by ions having larger radius (for example, K ions). A tensile stress layer 23 is formed inside the glass as the stress balances out.

In the present embodiment, the two compressive stress layers 21 and 22 have the same surface compressive stress and the same thickness (D1=D2). However, the compressive stress layers 21 and 22 may have different surface compressive stresses and different thicknesses.

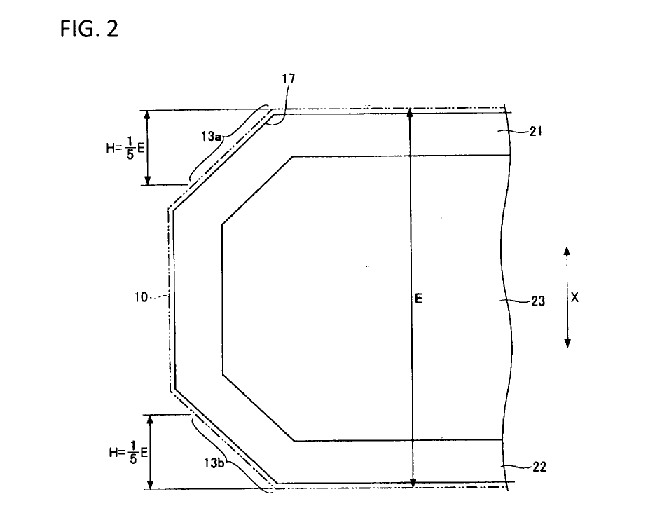

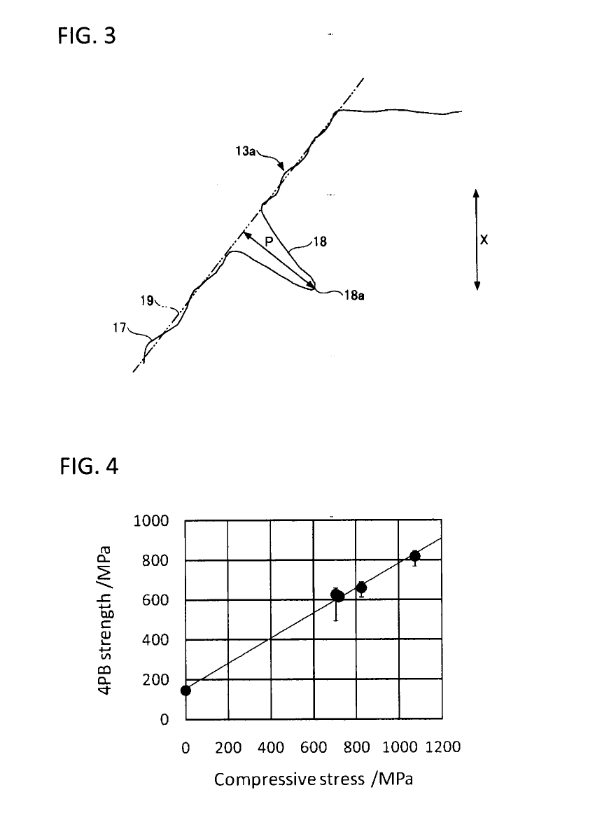

FIG. 2 is a cross sectional view showing the chemically strengthened glass plate 10 containing an etched end surface in the present embodiment. In FIG. 2, the solid line indicate the state after the etching of the chemically strengthened glass plate 10, and the dashed-two dotted line indicate the state before the etching of the chemically strengthened glass plate 10. FIG. 3 is a partially enlarged view of FIG. 2, representing an etching surface 17, a pit 18 formed in the etching surface 17, and the relationship between the etching surface 17 and an ideal surface 19.

In the present embodiment, the pit (latent scratch) 18 of more than 20 μm depth (preferably more than 15 μm, more preferably more than 10 μm) is absent in predetermined portions 13a and 13b of the end surface 13. The predetermined portions 13a and 13b are portions of the end surface 13 corresponding to distance H that is within ⅕ of the plate thickness E (H≦⅕×E) in a thickness direction from the main surfaces 11 and 12 adjacent to the chamfered portions 15 and 16.

The depth P of the latent scratch was measured in the following steps. First, the flat main surface of the chemically strengthened glass plate 10 is polished by a predetermined amount, followed by washing and drying. The surface is then subjected to etching treatment, and a processed altered layer with circular or ellipsoidal pits is observed with an optical microscope. As used herein, “processed altered layer” refers to a layer in which scratches, cracks or the like resulting from processing steps such as shaping, chamfering and grinding are present on the glass substrate. As an example thereof, observation was conducted at a microscopic field of 635 μm×480 μm with a 20 times objective lens of the optical microscope. This step (polishing, and checking of latent scratch after etching) was repeated multiple times, and the amount of etching at which the circular or ellipsoidal pits are no longer observed in the chemically strengthened glass plate 10 is determined as the “depth of latent scratch.”

Etching is performed at room temperature (25° C.) by immersing the whole portion of the chemically strengthened glass plate 10 in an etching solution. The etching solution may be an aqueous solution of 5 mass % hydrofluoric acid (HF) and 95 mass % pure water. The etching solution spreads the latent scratches by infiltrating into the latent scratches formed in the surface or inside the chemically strengthened glass plate 10. Etching is performed to make the latent scratch more easily observable.

Etching amount is controlled by immersion time. Specifically, etching is performed by adjusting immersion time so that the desired etching amount is achieved by using the previously calculated etching rate obtained from the etching performed for a glass of the same composition for a predetermined time period. Depending on the kinds of glass, the etching rate may be adjusted by varying the hydrofluoric acid concentration.

It should be noted here that the reason for checking only the predetermined portions 13a and 13b of the end surface 13 for the presence or absence of the pit 18 of 20 μm or more in depth is that, if any micro scratch is present in the predetermined portions 13a and 13b, the chemically strengthened glass plate 10 may be broken from the micro scratch as a starting point.

The present inventors have found that breakage progression in the chemically strengthened glass plate 10 can be classified into the following four categories: (1) breakages that occur from the end surface on the top surface side of the chemically strengthened glass plate; (2) breakages that occur from the end surface on the bottom surface side of the chemically strengthened glass plate; (3) breakages that occur from the main surface on the top surface side of the chemically strengthened glass plate; and (4) breakages that occur from the main surface on the bottom surface side of the chemically strengthened glass plate. A chemically strengthened glass plate that can withstand a variety of breakage conditions can be provided when it has high strength against all of these four kinds of breakages.

The conditions for obtaining a chemically strengthened glass plate having higher strength after being assembled into the actual display device could be found by measuring the strength in an environment similar to the state after assembly into the display device.

The breakages (1) and (2) are considered to occur as a result of a tensile stress being applied to the end surfaces of a chemically strengthened glass plate. Specifically, the breakages (1) and (2) can be suppressed by improving the bending strength of the chemically strengthened glass plate. In order to confirm this, samples each of which has different surface compressive stress (hereinafter, referred to as “CS”) produced by a chemical strengthening process were measured for bending strength in a 4-point bending test (JIS R1601) performed by leaving a 40-mm distance between two supporting points, and a 10-mm distance between two load points. The measurements were performed with Autograph AGS-X manufactured by Shimadzu Corporation.

FIG. 4 is a graph representing the relationship between CS and bending strength by the 4-point bending test. The bending strength increases with increase in CS. This measurement result confirmed that the breakages (1) and (2) can preferably be suppressed by increasing CS.

It has been thought that increasing the DOL value is generally effective for reducing the breakages in a chemically strengthened glass plate. However, in an attempt to reduce the breakages (1) and (2) by increasing the DOL value, the tendency that the strength is greatly improved was not confirmed even by increasing the DOL value when the DOL value was not less than a certain value, as shown in FIG. 5. FIG. 5 is a graph representing the relationship between the thickness of the surface compressive stress layer (DOL) and bending strength by a four-point bending test (JIS R1601) performed at room temperature. The samples having a size of 50 mm×50 mm×1.0 mm were used after CNC-polishing the end surfaces. The distance between two supporting points was 40 mm, and the distance between two load points was 10 mm. The mean value of 10 test samples was taken as the bending strength. Autograph AGS-X manufactured by Shimadzu Corporation was used for the 4-point bending test. From FIG. 5, DOL is preferably 20 μm or more and 35 μm or less from the standpoints of ensuring the bending strength and reducing the breakage (3), as will be described later.

In order to examine the relation between the strength and CS in the chemically strengthened glass plate from the standpoint of the breakage (4), samples each of which has different surface compressive stress CS produced by a chemical strengthening process were measured for fracture energy in a falling ball test. The falling ball test was performed by dropping a 130-g stainless steel on each fixed sample having a size of 50 mm×50 mm×0.7 mm.

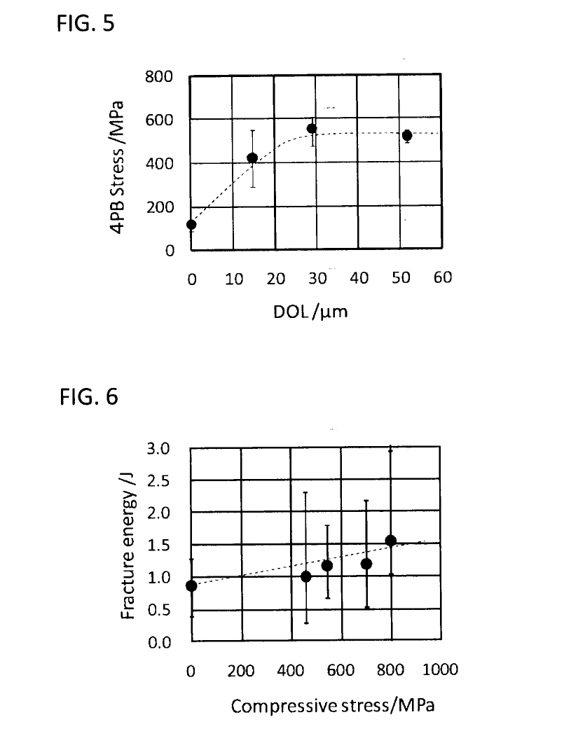

FIG. 6 shows a graph representing the relationship between CS and fracture energy by the falling ball test. The fracture energy increases with increase in CS. This measurement result confirmed that the breakage (4) can preferably be suppressed by increasing CS.

In order to suppress the breakage (3), it is considered desirable to reduce the internal tensile stress (hereinafter, referred to as “CT”). In order to examine the relation between strength and CT in the chemically strengthened glass plate from the standpoint of the breakage (3), the strength of the chemically strengthened glass plate was measured with a pyramidal diamond indenter with a vertex angle of 110° . Here, a pyramidal diamond indenter with a vertex angle of 110° was used because it was thought that the strength measurement for the breakage (3) would be performed more accurately with a sharper indenter than the case of a Vickers indenter.

Samples each of which has different CT produced by a chemical strengthening process were used to measure a load F₅₀ (unit: kgf) at which there is a 50% probability of breakage occurring under the applied load of the pyramidal diamond indenter having a vertex angle of 110° on a Vickers hardness tester. Also, F₅₀ (unit: kgf) can be converted to F₅₀ (unit: N) by the following formula: F₅₀ (unit: N)=9.8 F₅₀ (unit: kgf). The measurement was performed with Vickers hardness tester FLC-50V available from Future-Tech.

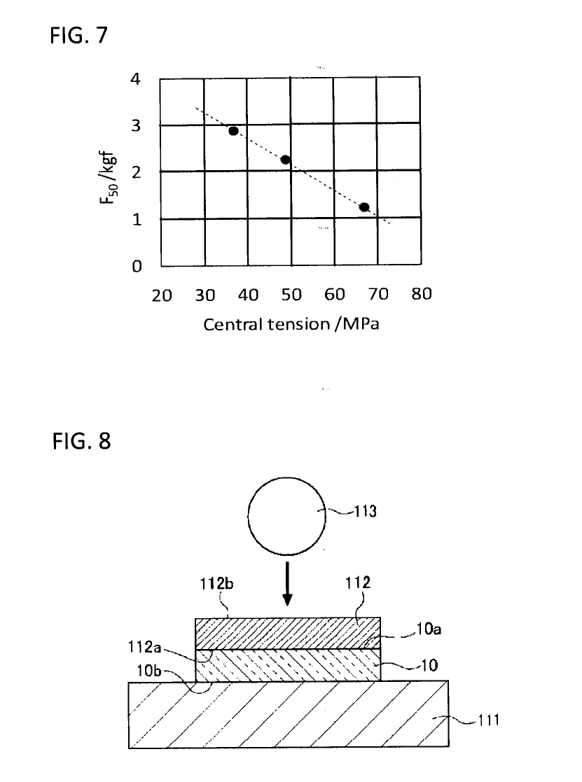

FIG. 7 shows a graph representing the relationship between CT and F₅₀ by the pyramidal indenter indentation test. Breakages occur under smaller loads as the CT increases. This measurement result confirmed that the breakage (3) can preferably be suppressed by lowering CT.

In addition to the pyramidal indenter indentation test, the present inventors conducted an experiment to reproduce the breakage (3), as shown in FIG. 8. As shown in FIG. 8, the chemically strengthened glass plate 10 having the surface compressive stress layer is placed on a base 111, and the chemically strengthened glass plate 10 is contacted with a grinding surface 112a of a sandpaper 112 containing an abrasive of a size not smaller than the depth of the compressive stress layer. A ball 113 such as an iron ball is then dropped from above. Here, the sandpaper 112 is placed on the chemically strengthened glass plate 10, and the grinding surface 112a of the sandpaper 112 is in contact with the top surface 10a of the chemically strengthened glass plate 10. The ball 113 is dropped on the surface 112b opposite to the grinding surface 112a of the sandpaper 112.

As first experiment conditions, a hard stone (hard base) such as granite was used as the base 111, P30 (D₃: 710 μm) was used as the sandpaper 112, and a 28-g SUS ball having a diameter of 0.75 inches was used as the ball 113. Experiment was conducted by dropping the ball 113 from different heights, and the cracking way developed in the chemically strengthened glass plate 10 was observed. Samples having a size of 50 mm×50 mm with three different thicknesses (1.0 mm, 0.7 mm, and 0.6 mm) were used as the chemically strengthened glass plate 10.

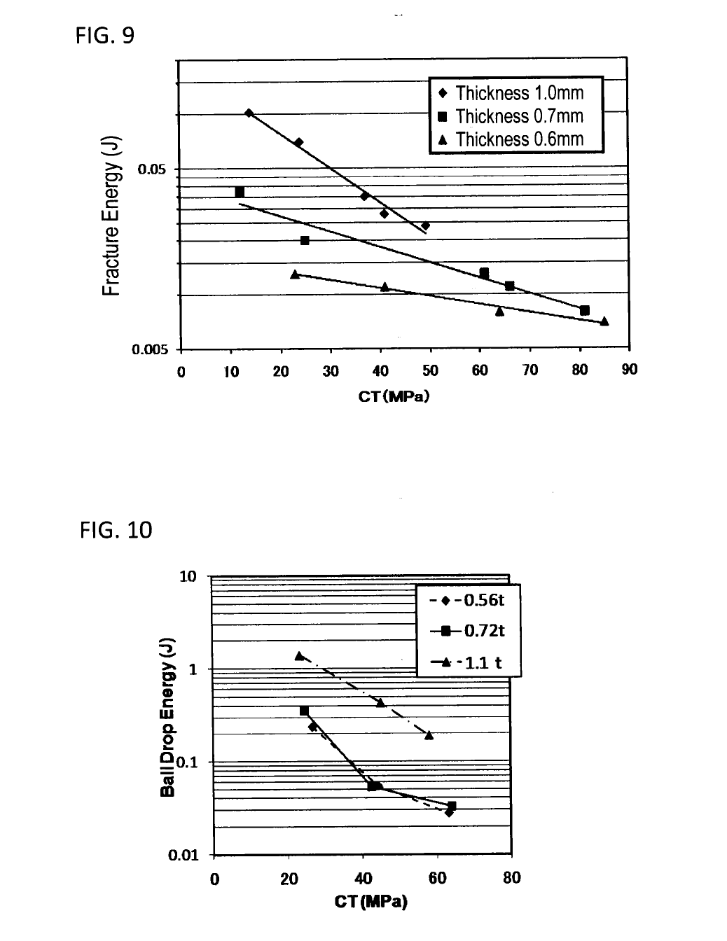

FIG. 9 is a graph representing changes in strength (fracture energy) with respect to changes of CT in a case of the experiment using the hard base. As can be seen from the result, the strength of the thinner samples of the glass plate is smaller than that of the thicker samples of the glass plate. It can also be seen that the strength increases as the CT decreases, regardless of the thickness of the glass plate. However, the degree of strength increase with decreasing CTs is smaller for thinner glass plates.

When a cover glass and a liquid crystal display are directly bonded to each other with a resin material or the like, most of the region on the main surface on the back surface side of the cover glass contacts the resin material that has a lower elastic modulus than the hard stone base. The present inventors contemplated that the chemically strengthened glass plate 10 might crack differently in the case where the main surface on the back surface side is contacted with a hard stone base and in the case where it is contacted with a soft base such as a resin material.

Then, the falling ball test was conducted under second experiment conditions, in which a soft material such as a resin material was used as the base 111 (a 3 mm-thick sponge was used in this experiment), P30 (D₃: 710 μm) was used as the sandpaper 112, and a 28-g SUS ball having a diameter of 0.75 inches was used as the ball 113. Experiment was conducted by dropping the ball 113 from different heights, and the cracking way developed in the chemically strengthened glass plate 10 was observed. Samples having a size of 50 mm×50 mm with three different thicknesses (1.10 mm, 0.72 mm, and 0.56 mm) were used as the chemically strengthened glass plate 10. The second experiment is intended to measure the strength of the chemically strengthened glass plate 10 under the conditions that more closely represent the actual conditions after assembly into a display device.

FIG. 10 is a graph representing changes in strength with respect to changes of CT in a case of the experiment using the soft base. It can be seen that the strength increase is notably high with CT of 42 MPa or less for glass plates having a thickness of 0.75 mm or less, whereas no notable changes of tendency were observed for glass plates having a thickness of 1.0 mm or more. It can be found from these results that glass plates having a thickness of 0.75 mm or less can have high strength even after assembly into the actual display device when at least the CT is 42 MPa or less. As can be seen in FIG. 10, the strength of the chemically strengthened glass plate can be greatly improved when the CT is 42 MPa, and the breakage (3) can be suppressed more effectively when the CT is 35 MPa or less, more preferably 30 MPa or less. Referring to FIG. 10, the CT is preferably 30 MPa because it provides the strength comparable to or higher than that provided by a 1.1-mm (CT=60 MPa) glass plate.

In the present embodiment, the strength of chemically strengthened glass plates was measured under the conditions that closely represent the actual condition after assembly into a display device. It was found as a result that the strength greatly increased when the CT was low, particularly in glass plates having a thickness of 0.75 mm or less. The following discussions of the embodiment of the present invention thus deal specifically with a chemically strengthened glass plate having a thickness of 0.75 mm.

The foregoing experiments revealed that the breakages (1), (2) and (4) can be suppressed by increasing CS, and that the breakage (3) can be suppressed by lowering CT. It is common that CT satisfies the relation CT=CS×DOL/(t−2DOL), where DOL is a thickness of a compressive stress layer, and t is a thickness of a chemically strengthened glass plate. As can be seen from this equation, it is difficult to achieve high CS values and low CT values at the same time, because increasing the CS value also increases the CT value in chemically strengthened glass plates each having the same thickness and the same DOL.

In the present embodiment, the chemically strengthened glass plate having a thickness of 0.75 mm or less can effectively suppress the breakage (3) even if the thinness of the glass plate is small. The tendency of the CT value to increase with increasing CS values becomes more prominent for glass plates having smaller thickness, and it is not practical to overly increase the CS value. Specifically, CS of 864 MPa or less is needed to obtain CT of 30 MPa or less for a chemically strengthened glass plate having a thickness of 0.75 mm and DOL of 30 μm. When DOL is 25 μm, CS of 980 MPa or less is needed to obtain CT of 35 MPa or less, and DOL is 30 μm and CT is 42 MPa or less, CS of 966 MPa or less is needed.

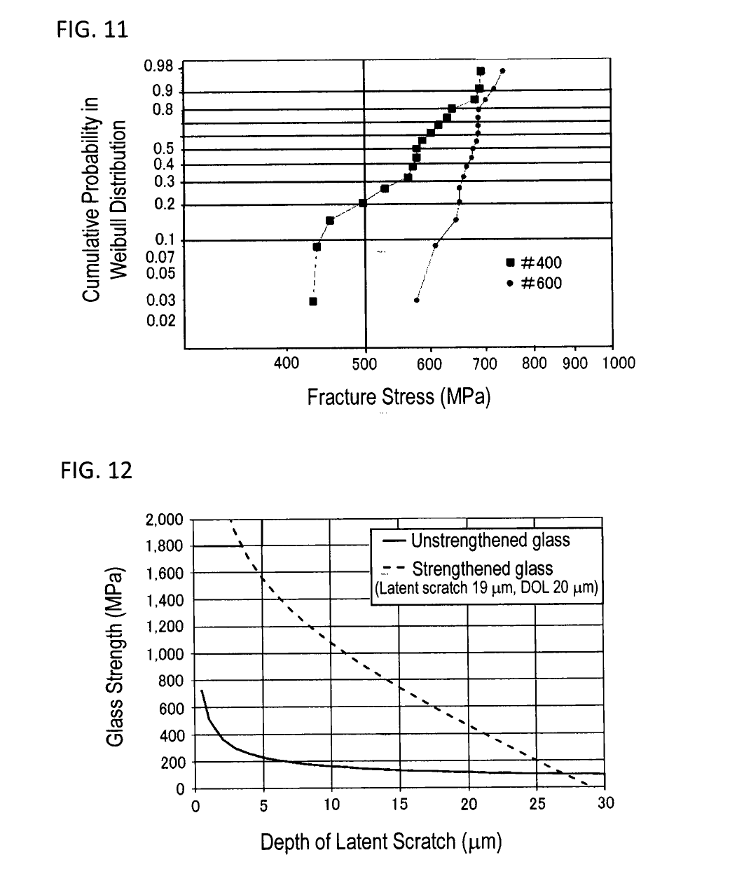

As described above, it becomes difficult to increase the CS value when the thickness of the chemically strengthened glass plate is smaller. Thus, the present inventors reduce the depth of the latent scratch in the end surfaces of the chemically strengthened glass plate as a means to increase bending strength without increasing the CS value. FIG. 11 is a Weibull plot representing the 4-point bending strength of the chemically strengthened glass plate in the present embodiment. Chemically strengthened glass plate samples having CS of 905 MPa, DOL of 22.7 μm, and a thickness of 1.1 mm were used. Each sample was chemically strengthened, and then, was chamfered with a grinding stone of a different grain number. The grains of the grinding stones #400 had an average grain size of 37 to 44 μm (maximum grain size of 75 μm), and the grains of the grinding stones and #600 had an average grain size of 26 to 31 μm (maximum grain size of 53 μm).

As can be seen from FIG. 11, some of the chemically strengthened glass plate samples ground with the #400 grinding stone had a bending strength of 500 MPa or less, whereas none of the chemically strengthened glass plate samples ground with the #600 grinding stone had a bending strength of 500 MPa or less. Given that chemically strengthened glass plates generally require a practical bending strength of 500 MPa or more, grinding with a #600 grinding stone enables providing a bending strength of 500 MPa or more while maintaining the CT equal to or less than the predetermined value. Grinding with a grinding stone with a grain number of #600 or more is also preferable from the standpoint of external appearance.

The glass plates were each measured for the depth of the latent scratch (pit) in the chamfered portions. The depth was at most 25 μm for the chemically strengthened glass plate ground with the #400 grinding stone, and at most 20 μm for the chemically strengthened glass plate ground with the #600 grinding stone. A chemically strengthened glass plate that can withstand even a greater variety of breakage conditions can thus be provided by making the depth of latent scratch (pit) 20 μm or less in the chamfered portions, specifically in portions corresponding to a distance that is within ⅕ of the plate thickness in a thickness direction from the main surfaces adjacent to the chamfered portions. From FIG. 11, the probability of damage occurring at a bending strength of 500 MPa or less was found to be about 20% in the chemically strengthened glass plate ground with the #400 grinding stone, specifically, in the chemically strengthened glass plate containing a latent scratch (pit) depth of at most 25 μm. On the other hand, the probability of breakage occurring at a bending strength of 500 MPa or less can be greatly reduced by controlling a latent scratch (pit) so as to be at most 20 μm in deep. Latent scratch depth was measured by repeating an etching process in the manner described above. The surface roughness Ra of the chemically strengthened glass plate was 0.43 μm for the chemically strengthened glass plate ground with the #400 grinding stone, and it was 0.26 μm for the chemically strengthened glass plate ground with the #600 grinding stone.

The average fracture strength (the stress value at fracture) σ_{f} of a glass plate not subjected to chemical strengthening can be calculated from the following equation 1. In the equation, K_{IC} is the fracture toughness, Y is the profile coefficient, and c is the depth of latent scratch.

$$\begin{matrix}[ Equation 1 ] & \\ {σ}_{f} = \frac{{K}_{IC}}{Y \sqrt{c}} & ( 1 )\end{matrix}$$

In the case of a chemically strengthened glass plate, in addition to the first term of the equation 1, the second term is necessary to be taken into consideration as shown in the equation 2 below. The second term can be increased by increasing CS or DOL, or by decreasing c. However, increasing CS or DOL also increases CT. Thus, even in a case where CS or DOL cannot be increased, the strength of the chemically strengthened glass plate can be increased by decreasing c.

$$\begin{matrix}[ Equation 2 ] & \\ {σ}_{f} = \frac{{K}_{IC}}{Y \sqrt{c}} + CS \times \frac{DOL - c}{DOL} & ( 2 )\end{matrix}$$

FIG. 12 is a graph representing the relationship between latent scratch depth and strength for a glass plate not subjected to chemical strengthening as shown in the equation 1, and a glass plate subjected to chemical strengthening as shown in the equation 2. It can be found that the effect of reducing the latent scratch depth c to increase glass strength is stronger for the chemically strengthened glass plate as compared with the glass plate not subjected to chemical strengthening, and that reducing the depth of latent scratch is very important for the strength of the chemically strengthened glass plate.

The graph of FIG. 12 was made after calculations on the basis that the fracture toughness K_{IC} is 0.72 MPa/m (calculated from experimental values), the profile coefficient Y is 0.14 for the glass plate not subjected to chemical strengthening (calculated from experimental values), and the profile coefficient Y is 0.035 for the chemically strengthened glass plate (calculated from experimental values by assuming that latent scratch depth c=19 μm, CS=850 MPa, and DOL=20 μm), the latent scratch depth c is 19 μm, and the DOL is 20 μm.

The method for producing the chemically strengthened glass plate in the present embodiment is not particularly limited, and the chemically strengthened glass plate may be produced by, for example, mixing various raw materials in appropriate amounts, heating to melt the mixture at about 1400 to 1800° C., homogenizing the molten glass by defoaming, agitating or the like, molding the glass into a plate form by using common methods such as a float method, a downdraw method, and a press method, and allowing the glass to cool and cutting the plate into a desired size.

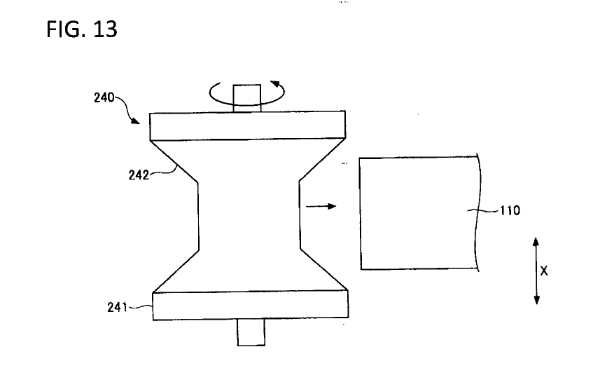

After being cut, the outer edge portions of the glass plate 110 are ground off with a rotary grindstone 240, as shown in FIG. 13. On the outer periphery surface 241 of the rotary grindstone 240, annular grinding grooves 242 that extend in the circumferential direction are formed. The wall surfaces of the grinding grooves 242 contain grains of alumina, silicon carbide, diamond or the like. The grains have a grain number (JIS R6001) of, for example, #300 to #2000. The grain number is measured based on JIS R6002. The grain size becomes larger as the grain number decreases, and thus, the efficiency of grinding is high. The rotary grindstone 240 rotates about its axis, and grinds off the outer edge portions of the glass plate 110 at the wall surfaces of the grinding grooves 242 while being moved relative to the glass plate 110 along the outer edge of the glass plate 110. A coolant such as water may be used during grinding. After grinding, a chemical strengthening process is performed, thereby obtaining the chemically strengthened glass plate.

The method used for the chemical strengthening process to obtain the chemically strengthened glass plate in the present embodiment is not particularly limited, as long as the Na in the glass surface can be replaced by K in the molten salt through the ion exchange. For example, the glass may be immersed in a heated potassium nitrate molten salt. As used herein, as potassium nitrate molten salts or potassium nitrate salts, examples thereof include KNO₃, and those containing KNO₃ and 10 mass % or less of NaNO₃. The chemical strengthening process conditions for forming the chemically strengthened layer (compressive stress layer) having the desired surface compressive stress depend on factors such as the thickness of the glass plate. Typically, the chemical strengthening process is performed by immersing the glass substrate in a 350 to 550° C. potassium nitrate molten salt for 2 to 20 hours. From the economic standpoint, the glass substrate is preferably immersed at 350 to 500° C. for 2 to 16 hour conditions, more preferably for 2 to 10 hours.

The glass transition point Tg of the glass in the chemically strengthened glass plate in the present embodiment is preferably 400° C. or more. When the glass transition point is less than 400° C., the surface compressive stress may be relaxed during the ion exchange, and a sufficient stress may not be obtained. The glass transition point Tg is more preferably 550° C. or more. The temperature T2 at which the viscosity of the glass in the chemically strengthened glass plate in the present embodiment reaches 10² dPa·s is preferably 1800° C. or less, more preferably 1750° C. or less. The temperature T4 at which the viscosity of the glass in the present embodiment reaches 10⁴ dPa·s is preferably 1350° C. or less.

The specific gravity p of the glass in the chemically strengthened glass plate in the present embodiment is preferably 2.37 to 2.55. The Young's modulus E of the glass in the chemically strengthened glass plate in the present embodiment is preferably 65 GPa or more. When the Young's modulus is less than 65 GPa, the rigidity or fracture strength of the glass as a cover glass may become insufficient. The Poisson's ratio σ of the glass in the chemically strengthened glass plate in the present embodiment is preferably 0.25 or less. When the Poisson's ratio is more than 0.25, the anti-cracking property of the glass may become insufficient.

The glass composition of the chemically strengthened glass plate of the present embodiment is described below. In the following, various contents are given in mole percent, unless otherwise stated.

SiO₂ is an essential component which constitutes a network of the glass. This component also reduces the occurrence of cracking when the glass surface is scratched (indented), or reduces the ratio of the destruction as might occur when the glass is indented after being chemically strengthened. When the content of SiO₂ is less than 56%, the stability, weather resistance or chipping resistance of the glass may be reduced. The content of SiO₂ is preferably 58% or more, more preferably 60% or more. When the content of SiO₂ is more than 75%, the glass viscosity may increase, and the meltability may be reduced.

Al₂O₃ is a component that effectively improves ion exchange performance and chipping resistance, and is essential as it increases the surface compressive stress, and reduces the occurrence of cracking upon forming an indentation by a 110° indenter. When the content of Al₂O₃ is less than 5%, the desired surface compressive stress or the desired compressive stress layer thickness may not be obtained even thorough the ion exchange. The content of Al₂O₃ is preferably 9% or more. When the content of Al₂O₃ is more than 20%, the glass viscosity may increase, and it becomes difficult to homogenously melt the glass. The content of Al₂O₃ is preferably 15% or less, typically 14% or less.

The total content of SiO₂ and Al₂O₃ (SiO₂+Al₂O₃) is preferably 80% or less. When the total content is more than 80%, the glass viscosity increases under high temperature, and it may become difficult to melt the glass. The total content is preferably 79% or less, more preferably 78% or less. SiO₂+Al₂O₃ is preferably 70% or more. When the SiO₂+Al₂O₃ is less than 70%, the resistance to cracking upon formation of an indentation may be reduced, and SiO₂+Al₂O₃ is more preferably 72% or more.

Na₂O is an essential component for forming the surface compressive stress layer by ion exchange, and improving the meltability of the glass. When the content of Na₂O is less than 8%, it becomes difficult to form the desired surface compressive stress layer even through the ion exchange. The content of Na₂O is preferably 10% or more, more preferably 11% or more. When the content of Na₂O is more than 22%, the weather resistance is reduced, and cracking tends to occur from an indentation. The content of Na₂O is preferably 21% or less.

K₂O increases the ion exchange rate, and may be contained in an amount of 10% or less, though this is not an essential component. When the content is more than 10%, cracking tends to occur from an indentation, and the concentration of NaNO₃ in the potassium nitrate molten salt may lead to large change of the surface compressive stress. The content of K₂O is 5% or less, more preferably 0.8% or less, further preferably 0.5% or less, and is typically 0.3% or less. It is preferable not to contain K₂O when the change of surface compressive stress due to the concentration of NaNO₃ in the potassium nitrate molten salt need to be reduced.

MgO is an essential component for increasing the surface compressive stress, and improving the meltability. It is preferable to contain MgO when stress relaxation needs to be reduced. When MgO is not contained, stress relaxation tends to occur to different extents in different locations of the chemical strengthening process tank because of variation in the molten salt temperature in the chemical strengthening process, and it may become difficult to obtain a stable compressive stress value. When the content is more than 14%, the glass tends to devitrify, and the concentration of NaNO₃ in the potassium nitrate molten salt may lead to large change of surface compressive stress. The MgO content is preferably 13% or less.

SiO₂—MgO is preferably 64% or less, more preferably 62% or less, and is typically 61% or less. Al₂O₃—MgO is preferably 9% or less, more preferably 8% or less. The total content of SiO₂, Al₂O₃, Na₂O, and MgO is preferably 98% or more. When the total is less than 98%, it may become difficult to obtain the desired compressive stress layer while maintaining the cracking resistance. The total is typically 98.3% or more.

ZrO₂ may be contained in an amount of at most 5% for lowering the viscosity at high temperature, or increasing the surface compressive stress, though this is not an essential component. When the content of ZrO₂ is more than 5%, the possibility of cracking from an indentation may increase. For this reason, the content is preferably 2% or less, more preferably 1% or less, and ZrO₂ is typically not contained.

B₂O₃ is not an essential component, but may be contained in an amount of 6% or less for improving meltability at high temperature, increasing glass strength or the like. When the content of B₂O₃ is more than 6%, it becomes difficult to obtain a homogenous glass. This may cause difficulties in forming the glass, or may lower the cracking resistance. Typically, B₂O₃ is not contained.

The total content of SiO₂, Al₂O₃, Na₂O, and MgO is preferably 98% or more.

While the preferred glass components of the chemically strengthened glass plate in the present embodiment consist essentially of the components as described above, the chemically strengthened glass plate may contain other components, as long as it does not impair the object of the present invention. When such components are contained, the total content of these components is preferably less than 2%, more preferably 1% or less. The following describes examples of such other components.

ZnO may be contained in an amount of, for example, at most 2% for improving the meltability of the glass under high temperature. Preferably, ZnO is contained in an amount of 1% or less, and may be preferably contained in an amount of 0.5% or less when the glass is produced by a float method. When the content of ZnO is more than 0.5%, defects may be included in a product as a result of reduction during float forming. Typically, ZnO is not contained. TiO₂ is typically not contained, and when it is contained, it is contained in an amount of preferably 1% or less because TiO₂ may co-exist with Fe ions present in the glass, thereby lowering visible light transmittance and coloring the glass to brown.

Li₂O facilitates stress relaxation by lowering the strain point, and acts against obtaining a stable surface compressive stress layer. It is therefore preferable not to contain this component. When Li₂O is contained, it is contained in an amount of preferably less than 1%, more preferably 0.05% or less, particularly preferably less than 0.01%.

Li₂O may dissolve into a molten salt such as KNO₃ during the chemical strengthening process, and a chemical strengthening process that uses a Li-containing molten salt severely lowers the surface compressive stress. From this standpoint, it is therefore preferable not to contain Li₂O.

CaO may be contained in an amount of 5% or less for improving meltability under high temperature or preventing devitrification. When the content of CaO is more than 5%, ion-exchange rate may be lowered or resistance to cracking may be lowered. Typically, CaO is not contained. SrO may be contained, as required. However, when contained, SrO is contained in an amount of preferably less than 1% because SrO has a greater effect to lower ion-exchange rate as compared to the cases of MgO and CaO. Typically, SrO is not contained. BaO has the strongest effect to lower ion-exchange rate among alkali earth metal oxides. It is accordingly preferable not to contain BaO, or contain BaO in an amount of less than 1% when it is contained.

When SrO or BaO is contained, the total content of these components is preferably 1% or less, more preferably less than 0.3%.

When one or more of CaO, SrO, BaO, and ZrO₂ are contained, the total content of these four components is preferably less than 1.5%. When the total content is 1.5% or more, the ion-exchange rate may be lowered. The total content is typically 1% or less.

Refining agents such as SO₃, chlorides, and fluorides may be appropriately contained for the melting of the glass. However, components having absorption in the visible range, such as Fe₂O₃, NiO and Cr₂O₃ that may be included as impurities in the raw material should preferably be reduced as much as possible in order to improve the viewability of a display device such as a tough panel. The content of each such component is preferably 0.15 mass % or less, more preferably 0.05 mass % or less.

As described above, the chemically strengthened glass plate in the present embodiment has a thickness of 0.75 mm or less, and CS of 850 MPa or more, CT of 42 MPa or less, and end surfaces in which the depth of a latent scratch is reduced to 20 μm or less, for suppressing the breakages (1) to (4).

The present invention is not limited to the foregoing embodiment, and may be appropriately altered within the gist of the present invention. For example, given the same CS and thickness, it is easy to reduce the CT value by making the DOL smaller. It is therefore preferred that, when the DOL is 20 to 25 μm, the CT is 30 MPa or less.

While the invention has been described in detail and with reference to specific embodiments thereof, it will be apparent to one skilled in the art that various changes and modifications can be made therein without departing from the spirit and scope thereof.

### Reference Signs List

10 Chemically strengthened glass plate

11, 12 Main surface

13 End surface

13a, 13b Predetermined portion of end surface

15, 16 Chamfered portion

17 Etching surface

18 Pit (latent scratch)

21, 22 Chemically strengthened layer (compressive stress layer)

23 Tensile stress layer

1. A chemically strengthened glass plate comprising a top main surface, a bottom main surface and end surfaces between the top main surface and the bottom main surface, and comprising a compressive stress layer in a whole surface of the main surfaces and end surfaces,
wherein the chemically strengthened glass plate has a thickness of 0.75 mm or less, a surface compressive stress of 850 MPa or more, a thickness of the compressive stress layer of 20 to 35 μm and an internal tensile stress of 42 MPa or less, and
the end surface has a chamfered portion, and a depth of a latent scratch is 20 μm or less in a portion of the end surface corresponding to a distance that is within ⅕ of the thickness of the chemically strengthened glass plate in a thickness direction from the main surface adjacent to the chamfered portion.

2. The chemically strengthened glass plate according to claim 1, wherein the thickness of the surface compressive stress layer is 20 to 30 μm.

3. The chemically strengthened glass plate according to claim 2, wherein the thickness of the surface compressive stress layer is 20 to 25 μm.

4. The chemically strengthened glass plate according to claim 3, wherein the internal tensile stress is 30 MPa or less.

5. The chemically strengthened glass plate according to claim 1, wherein the surface compressive stress is 966 MPa or less.

6. The chemically strengthened glass plate according to claim 1, wherein the internal tensile stress is 35 MPa or less.

7. The chemically strengthened glass plate according to claim 6, wherein the surface compressive stress is 980 MPa or less.

8. The chemically strengthened glass plate according to claim 6, wherein the internal tensile stress is 30 MPa or less.

9. The chemically strengthened glass plate according to claim 1, wherein a bending strength by a 4-point bending test is 500 MPa or more.

10. The chemically strengthened glass plate according to claim 7, wherein the chamfered portion is polished with a grinding stone with a grain number of #600 or more.

11. The chemically strengthened glass plate according to claim 1, a load F₅₀ (unit: kgf) at which there is a 50% probability of breakage occurring under an applied load of a pyramidal diamond indenter having a vertex angle of 110° on a Vickers hardness tester is 2.5 kgf or more.

12. The chemically strengthened glass plate according to claim 1, which has a Young's modulus of 65 GPa or more.

13. The chemically strengthened glass plate according to claim 1, which has a Poisson's ratio of 0.25 or less.

14. The chemically strengthened glass plate according to claim 1, comprising, as represented by mole percentage based on the following oxides: from 56 to 75% of SiO₂; from 5 to 20% or Al₂O₃; from 8 to 22% of Na₂O; from 0 to 10% of K₂O; from 0 to 14% of MgO; from 0 to 5% of ZrO₂; and from 0 to 5% of CaO.

15. The chemically strengthened glass plate according to claim 14, wherein a total content of SiO₂, Al₂O₃, Na₂O and MgO is 98% or more.

16. The chemically strengthened glass plate according to claim 14, wherein SiO₂—MgO is 64% or less.

17. The chemically strengthened glass plate according to claim 14, wherein Al₂O₃—MgO is 9% or less.

18. The chemically strengthened glass plate according to claim 14, wherein ZrO₂ is contained in an amount of 0 to 2%.

19. The chemically strengthened glass plate according to claim 14, wherein B₂O₃ is contained in an amount of 0 to 6%.

20. The chemically strengthened glass plate according to claim 14, wherein Li₂O is contained in an amount of 0 to 1%.
